(19) United States
(12) Patent Application Publication
(10) Pub. No.: US 2025/0268386 A1
(43) Pub. Date: Aug. 28, 2025

(54) Modular Bed Base

(71) Applicant: Sleeping Duck Pty Ltd, Prahran (AU)

(72) Inventors: Phaon Phipat, Prahran (AU); William Loft, Prahran (AU); Winston Wijeyeratne, Prahran (AU); Callum Ellis, Prahran (AU)

(21) Appl. No.: 18/286,572

(22) PCT Filed: Apr. 13, 2022
(86) PCT No.: PCT/AU2022/050328

§ 371 Date: Oct. 12, 2023

(30) Foreign Application Priority Data
Apr. 13, 2021 (AU) 2021901076
Jun. 15, 2021 (AU) 2021901791
Aug. 20, 2021 (AU) 2021106152
Aug. 20, 2021 (AU) 2021106156

(51) Int. Cl. A47C 19/00; A47C 19/02

(52) U.S. Cl. CPC A47C 19/005; A47C 19/021

(57) ABSTRACT

The invention is directed to a modular bed base system, including a frame configured from a front rail, a back rail and a pair of side rails, the frame providing a plurality of mounting features; a support member configured to engage with and span the frame; and a set of interchangeable cladding panels configured to form an ornamental perimeter about the frame, the set of interchangeable cladding panels selected from a plurality of sets of interchangeable cladding panels providing a selectable theme. Each set of interchangeable cladding panels provides common co-operating mounting features adapted to releasably engage the mounting features of the frame to thereby vary at least one of shape, colour and texture of the ornamental perimeter in accordance with the selectable theme.

### CROSS REFERENCE TO RELATED APPLICATIONS

This application is the United States national phase of International Patent Application No. PCT/AU2022/050328 filed Apr. 13, 2022, and claims priority to Australian Patent Application No. 2021901076 filed Apr. 13, 2021, Australian Patent Application No. 2021901791 filed Jun. 15, 2021, Australian Patent Application No. 2021106152 filed Aug. 20, 2021, and Australian Patent Application No. 2021106156 filed Aug. 20, 2021, the disclosures of which are hereby incorporated by reference in their entireties.

### BACKGROUND OF THE INVENTION

### Field of the Invention

The present technology generally relates to a modular bed base and a modular bed base system comprising a bed frame with interchangeable cladding panels. The invention also relates to a bed having a frame with interchangeable bed cladding panels.

### Description of Related Art

Modern bed bases and frames are typically designed to provide visual appeal and aesthetics, while having the capacity for storage. However, while a user may decorate a bed in a variety of ways (with different pillows, throws, blankets, and/or sheets, for example) the visual features of the bed base or frame structure per se do not change.

In order to meet consumer demand, manufacturers and retailers need to acquire a relatively large inventory so as to satisfy customers with different preferences, but also to stay current with trends in fashion and home decor.

Accordingly, there is a need for bed bases and bed frames that enable consumers to adapt their bed's visual appeal and aesthetics to suit their own change in preferences and/or trends. At the same time, there is a need to provide manufacturers and retailers with flexibility and agility in managing bed base and bed frame inventory.

### SUMMARY OF THE INVENTION

This summary is provided to introduce a selection of concepts in a simplified form that are further described below in the Detailed Description. This summary is not intended to identify key features of the claimed subject matter, nor is it intended to be used as an aid in determining the scope of the claimed subject.

The present disclosure provides a modular bed base with interchangeable cladding panels, a modular bed base system with a plurality of interchangeable cladding panels, and a bed having the same.

According to a first aspect of the invention, there is provided a modular bed base system, comprising: a frame configured from a front rail, a back rail and a pair of side rails, the frame providing a plurality of mounting features; a support member configured to engage with and span the frame, the support member extending parallel to the pair of side rails and disposed centrally of the front and back rails of the frame; and a set of interchangeable cladding panels configured to form an ornamental perimeter about the frame, the set of interchangeable cladding panels selected from a plurality of sets of interchangeable cladding panels providing a selectable theme, wherein each set of interchangeable cladding panels provides common co-operating mounting features adapted to releasably engage the mounting features of the frame to thereby vary at least one of shape, colour and texture of the ornamental perimeter in accordance with the selectable theme.

In some embodiments, each set of interchangeable cladding panels may comprise four panels to form a closed ornamental perimeter about the frame. In some embodiments, each set of interchangeable cladding panels may comprise three panels. In some embodiments, each set of interchangeable cladding panels may comprise three panels and a bed head to form a closed ornamental perimeter about the frame. The selectable themes may comprise different: materials; geometry; colour; padding; pattern; and texture.

According to the second aspect of the invention, there is provided a modular bed base, comprising: a frame configured from a front rail, a back rail and a pair of side rails; support member configured to engage with and span the frame, the support member extending parallel to the pair of side rails and disposed centrally of the front and back rails of the frame; and a plurality of cladding panels adapted to at least partially cover the frame, wherein at least one of the front rail and the pair of side rails comprise a plurality of mounting features configured to engage with a plurality of co-operating mounting features of the plurality of cladding panels to mount the cladding panels to a periphery of the frame.

In some embodiments the support member may comprise a pair of centrally disposed rail. In some embodiments the support member is oriented perpendicular to the side panels. In some embodiments the support member comprises a plurality of support members extending across the frame for supporting a mattress thereon. The mattress may be supported directly or indirectly by the at least one support member.

In one embodiment at least the front rail and the side rails may include a plurality of keyholes, and a plurality of cladding panels may be configured to be detachably attached to at least the front rail and the side rails through the keyholes.

According to a third aspect of the invention, there is provided a modular bed base, having a bed frame, comprising: a front rail; a back rail; and two side rails, each of the front rail and the two side rails including a plurality of apertures; and a support member configured to engage with and span the frame, the support member extending parallel to the pair of side rails and disposed centrally of the front rail and the back rail of the frame, wherein a plurality of interchangeable cladding panels are configured to be detachably mounted to at least the front rail and the two side rails via the plurality of apertures.

According to a fourth aspect of the invention, there is provided a bed, comprising: a modular bed base or a modular bed base system as described herein; and a mattress supported on the modular bed base.

In some embodiments, there is provided a bed, comprising: a frame structure; and a bedhead attached to the frame structure, wherein the frame structure comprises: a front rail; a back rail; and two side rails, wherein at least the front rail and the side rails include a plurality of slots, and wherein a plurality of cladding panels are configured to be detachably attached to at least the front rail and the side rails.

In one embodiment, at least the front rail and the side rails may include a plurality of keyholes, and a plurality of cladding panels may be configured to be detachably attached to at least the front rail and the side rails through the keyholes.

According to some embodiments, there is provided a bed base frame, comprising: a front rail; a back rail; and two side rails, wherein at least the front rail and the side rails include a plurality of slots, and wherein a plurality of cladding panels are configured to be detachably attached to at least the front rail and the side rails.

According to some embodiments of the modular bed base the frame is adorned with different external bed cladding panels. The external bed cladding panels are interchangeable and thus allow a user to easily change the bed's visual appearance without changing the frame structure of the bed base. The interchangeable cladding panels also help manufacturers and retailers improve efficiency in inventory management and further reduce the costs of introducing new modular bed bases and beds that have new aesthetic designs by way of the interchangeable cladding panels.

In a fifth aspect, the invention provides a tensionable furniture leg, for mounting between two support surfaces of a piece of furniture, the leg comprising: a foot having an operative portion and a support portion, the operative portion providing an external thread; an internally threaded spacer having a first open end and a second open end, configured to be located between the two support surfaces of the piece of furniture, the first open end configured to receive the external thread of the foot through a first of the two support surfaces; and a closer having a head and an externally threaded stem, the threaded stem configured to be received in the second open end of the spacer through a second of the two support surfaces of the piece of furniture, wherein the closer and the foot are threadingly received in opposing ends of the spacer through the first and second support surfaces of the piece of furniture, to locate the leg and adjustably tension the leg between the two support surfaces.

In some embodiments, the leg may further comprise a locking member. The locking member may be seated on the foot between the operative portion and the support portion. The locking member may be selectively lockable to the foot thereby securing the first of the two support surfaces between the locking member and the first open end of the spacer. The locking member may be a lockable collar. The locking member may be an annular collar. The lockable collar may comprise a screw oriented to be driven towards the external thread of the foot to frictionally engage therewith. The external thread of the foot may be integrally formed therewith. The external thread of the foot may comprise an externally threaded sleeve mounted to the operative portion of the foot. The externally threaded sleeve may be frictionally coupled to the operative portion of the foot.

The foot may be made from any one of the following materials: a metal, a wood, a plastic, a composite, and combinations thereof. A diameter of the head of the closer may be larger than a diameter of the threaded stem to define a clamping area over which force is applied to the second of the two support surfaces of the piece of furniture. The head of the closer may be planar.

In some embodiments, an exterior of the closer may provide a gripping portion for a user to engage, when tensioning the closer against the spacer. The gripping portion may be knurled.

The operative portion of the foot may be cylindrical. The support portion of the foot may be cylindrical. The operative portion of the foot may be cylindrical and the support portion of the foot is not cylindrical. The internally threaded spacer may be configured to receive an M39 thread.

In some embodiments, the invention may provide a modular bed base, comprising a tensionable furniture leg as described herein.

In a sixth aspect, the invention provides a modular bed head comprising: a pair of elongate mounts, each mount having a transverse arm and an upright arm; and a support panel illustrated as a headboard having a decorative face and an opposing plain face, the headboard I providing a pair of recesses therein, each recess partially housing one of the pair of elongate mounts, each recess having an first opening extending from the plain face of the headboard and a second opening extending from the decorative face of the headboard, wherein a portion of the transverse arm of each mount is exposed from the decorative face of the headboard and the upright arm of each mount is fully encased within the recesses of the headboard.

In some embodiments, the first openings may be elongate and extend along a substantial height of the headboard. The second openings may be elongate and extend along a portion of the height of the headboard. A length of the first openings may be at least three times a length of the second openings.

In some embodiments, the modular bed head may further comprise a plurality of fasteners for securing each of the mounts to the plain face of the headboard. The portion of the transverse arm exposed from the headboard may provide at least one mounting aperture for mounting the modular bed head to a bed frame. Each of the pair of elongate mounts may be L-shaped in cross-section.

The headboard may comprise at least one of timber, metal, composite, ply board or combinations thereof. The pair of elongate mounts may be made from any one of the following materials: a metal; timber, a plastic, a composite and any combination thereof. The headboard may be upholstered or padded.

In some embodiments, a modular bed base may comprises a modular bed head as described herein.

In a seventh aspect, the invention provides a tensionable furniture leg, for mounting between two support surfaces of a piece of furniture, the leg comprising: a foot having an operative portion and a support portion the operative portion have a central aperture for receiving a threaded cap; an internally threaded spacer having a first open end and a second open end, configured to be located between the two support surfaces of the piece of furniture, the first open end configured to receive the threaded cap extending through the central aperture of the foot and a first of the two support surfaces; and a closer having a head and an externally threaded stem, the threaded stem configured to be received in the second open end of the spacer through a second of the two support surfaces of the piece of furniture, wherein the closer and the threaded cap are threadingly received in opposing ends of the spacer through the first and second support surfaces of the piece of furniture, to clamp the operative portion of the foot to the first of the two support surfaces and adjustably tension the leg between the two support surfaces.

In some embodiments, the operative portion of the foot may comprise a foot plate configured to abut the first of the two support surfaces. The operative portion of the foot may further comprise an upturned flange resisting rotation of the foot under tension. The support portion of the foot may be selected from any one of the following styles: an ornate member; an arcuate member; an angled member; a tubular member; a thin cylindrical member; and a thick cylindrical member.

It should be understood that the outcomes described herein are not limited, and may be any of or different from the outcomes described in the present disclosure. To this point, other embodiments of the invention will be evident from the following detailed description of various aspects of the invention.

### BRIEF DESCRIPTION OF THE DRAWINGS

The terms FIG., FIGS., Figure, and Figures are used interchangeably in the specification to refer to the corresponding figures in the drawings

Features of a bed base frame with interchangeable bed cladding panels and a bed having the same, as described herein may be better understood by reference to the accompanying drawings in which:

FIG. 1A is an exploded perspective view of a modular bed base according to one embodiment of the invention, illustrating a plurality of bed cladding panels configured to be mounted around a bed frame.

FIG. 1B is an exploded perspective view of a modular bed base of another embodiments of the invention, illustrating bed cladding panels and a bedhead aligned for mounting to the bed frame.

FIG. 1C is an enlarged view from Circle A of the modular bed base from FIG. 1B, showing a bed head mounting bracket mounted to the frame.

FIGS. 2A-2D are side, perspective, front and top views of a bed frame illustrating a plurality of slots for bed head location and additional mounting features for engaging cladding panels thereto.

FIGS. 3A-3D are side, end, top and perspective views of planar cladding panels for covering a portion of the frame in conjunction with a bed head

FIGS. 4A-4D are side, end, top and perspective views of profiled cladding panels for covering a portion of the frame in conjunction with a bed head, the profiled cladding panels having a padding or upholstery applied thereto.

FIGS. 5A-5D are side, end, top and perspective views of platform cladding panels for covering a portion of the frame in conjunction with a bed head, the platform cladding panels providing an angled platform around the frame.

FIG. 6A is a perspective view of a curved bed head for engaging with a frame to form a modular bed base according to one embodiment of the invention.

FIG. 6B is a perspective view of a flat, bed head for engaging with a frame to form a modular bed base according to one embodiment of the invention.

FIGS. 7A-7D illustrate a bed with a series of interchangeable cladding panels according to an embodiment of the invention, wherein:

FIG. 7A is a perspective view of a modular bed base having a solid timber cladding and a bed flat head;

FIG. 7B is a perspective view of a modular bed base having a profiled, upholstered cladding and a bed flat head;

FIG. 7C is a perspective view of a modular bed base having an angled cladding forming a peripheral platform around the frame; and

FIG. 7D is a perspective view of a modular bed base having storage cladding panels forming a periphery around the entire frame.

FIGS. 8A-8D illustrate a bed with a series of interchangeable cladding panels and a support platform, according to an embodiment of the invention, wherein:

FIG. 8A is a perspective view of a modular bed base having a solid timber cladding, a support platform and a bed flat head;

FIG. 8B is a perspective view of a modular bed base having a profiled, upholstered cladding, a support platform and a bed flat head;

FIG. 8C is a perspective view of a modular bed base having an angled cladding forming a peripheral platform around the frame and a support platform; and

FIG. 8D is a perspective view of a modular bed base having storage cladding panels forming a periphery around the entire frame and a support platform.

FIG. 9A is a top view of an overhang cladding panel according to an embodiment of the invention.

FIG. 9B is an end view of the overhang cladding panel of FIG. 9A.

FIG. 9C is a perspective view of a modular bed base illustrating a plurality of overhanging cladding panels disposed around a periphery of the frame and interlocked with a support platform atop the frame.

FIGS. 10A-10C illustrate a series of schematic drawings of a hook-on attachment mechanism according to an embodiment of the invention, wherein:

FIG. 10A illustrates a cladding panel mounted and secured to a rail of a bed base frame;

FIG. 10B illustrates a cladding panel mounted, and not yet secured to the rail of the bed base frame;

FIG. 10C illustrates a cladding panel aligned with the rail of the bed base frame, prior to mounting thereto;

FIG. 11A illustrates a front perspective view of a bed head according to one embodiment of the invention;

FIG. 11B illustrates a rear perspective view of the bed head of FIG. 11A;

FIG. 12A illustrates a perspective view of a pair of bed head mounting brackets mounted to the bed frame, with the bed head removed;

FIG. 12B illustrates an exploded view of the bed head mounting of FIG. 12A, with the bed head aligned between the mounting brackets and the bed frame;

FIG. 13A illustrates the pair of mounting brackets oriented with peripheral edges of the bed head, to be inserted and threaded through slots in the bed head;

FIG. 13B illustrates the mounting brackets captures in a sheath or housing of the bed head with a bed frame mounting portion of each bracket exposed at a front surface of the bed head;

FIGS. 14A-14F illustrate components of a bed leg assembly according to one embodiment of the invention, where: FIG. 14A is a side view of a spacer for inserting into the bed frame;

FIG. 14B is a cross-sectional view along line A-A of FIG. 14A, illustrating an internal thread to the spacer;

FIG. 14C is a perspective view of a foot of the leg assembly having a thick lower portion and a thinner dowel portion towards an upper portion of the foot;

FIG. 14D is a perspective view of an externally threaded sleeve for cooperating with the internal thread of the spacer;

FIG. 14E is a perspective view of a collar for adjusting and locking the foot against the spacer; and

FIG. 14F is a side view of a closer or button for sealing a top portion of the spacer once the leg assembly is located within the bed frame;

FIG. 15A illustrates a perspective view of the leg assembly in an assembled configuration, as used when attached to the bed frame;

FIG. 15B is a side view of the leg assembly of FIG. 15A illustrating a grub screw or Allen head screw for locking the collar in position onto the externally threaded sleeve locking the leg assembly in position;

FIG. 15C is a cross-sectional view along line B-B of FIG. 15B illustrating the leg assembly in a tightened configuration;

FIG. 16A is a perspective view of the leg assembly mounted in a C-section side rail of the bed frame;

FIG. 16B is an exploded view of the leg assembly of FIG. 16A co-axially aligned with an aperture in the side rail for inserting and tightening the leg assembly therein;

FIG. 17A illustrates and alternative leg assembly according to another embodiment of the invention, comprising a foot plate, a spacer and an upper and a lower button to seal both ends of the spacer once in position in the bed frame;

FIG. 17B illustrates a small foot plate configured to be located within a C-section of the bed side-rail;

FIG. 17C illustrates a large foot plate configured to be located externally of a C-section of the bed side-rail;

FIG. 17D illustrates a rear rail and a side rail of the frame interlocked with each other forming a circular bed leg mounting aperture and a large foot plate aligned to be positioned under the rails;

FIG. 18A illustrates a bed base with an alternative leg design, where an ornamental leg comprises the large foot plate with an ornamental foot welded or otherwise attached thereto;

FIG. 18B illustrates a side view of the ornamental leg, and a locking flange extending upwardly therefrom;

FIG. 18C is a plan view of the ornamental leg of FIG. 18B;

FIG. 18D is a perspective view of the ornamental leg of FIG. 18B illustrating a pair of arcuate side walls to the foot;

FIG. 19A illustrates a bed base with an alternative leg design, where an angled leg comprises the large foot plate with an angled foot welded or otherwise attached thereto;

FIG. 19B illustrates a side view of the angled leg, and a locking flange extending upwardly therefrom;

FIG. 19C is a plan view of the angled leg of FIG. 19B;

FIG. 19D is a perspective view of the angled leg of FIG. 19B illustrating a pair of angled side walls to the foot;

FIG. 20A illustrates a bed base with an alternative leg design, where a thick cylindrical leg comprises the large foot plate with a thick cylindrical foot welded or otherwise attached thereto;

FIG. 20B illustrates a side view of the thick cylindrical leg, and a locking flange extending upwardly therefrom;

FIG. 20C is a plan view of the thick cylindrical leg of FIG. 20B;

FIG. 20D is a perspective view of the thick cylindrical leg of FIG. 20B;

FIG. 20E is a perspective view of a castor comprising a rolling element encased in a mounting cup configured to be inserted into a lower portion of the thick cylindrical foot;

FIG. 21A illustrates a bed base with an alternative leg design, where a thin cylindrical leg comprises the large foot plate with a thin cylindrical foot welded or otherwise attached thereto;

FIG. 21B illustrates a side view of the thin cylindrical leg, and a locking flange extending upwardly therefrom;

FIG. 21C is a plan view of the thin cylindrical leg of FIG. 20B;

FIG. 21D is a perspective view of the thin cylindrical leg of FIG. 20B;

FIG. 22A illustrates a bed base with an alternative leg design, where an angled tubular leg comprises the large foot plate with an angled tubular foot welded or otherwise attached thereto;

FIG. 22B illustrates a side view of the angled tubular leg, and a locking flange extending upwardly therefrom;

FIG. 22C is a plan view of the angled tubular leg of FIG. 22B; and

FIG. 22D is a perspective view of the angled tubular leg of FIG. 22B.

### DESCRIPTION OF THE INVENTION

The embodiments will now be described more fully hereinafter with reference to the accompanying drawings, in which some, but not all embodiments of the present technology are shown. Indeed, the present technology may be embodied in many different forms and should not be construed as limited to the embodiments set forth herein.

Likewise, many modifications and other embodiments of the bed base frame and the bed described herein will come to mind to one of skill in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The present disclosure relates to a modular bed base system, including a bed base or a bed having interchangeable bed cladding panels. The cladding panels vary in material, geometry, colour, padding, pattern and texture to provide a plurality of sets of interchangeable cladding panels with a selectable theme, forming an ornamental perimeter about the frame. Each set of interchangeable cladding panels provides common co-operating mounting features adapted to releasably engage mounting features of the frame to thereby vary the ornamental perimeter in accordance with the selectable theme.

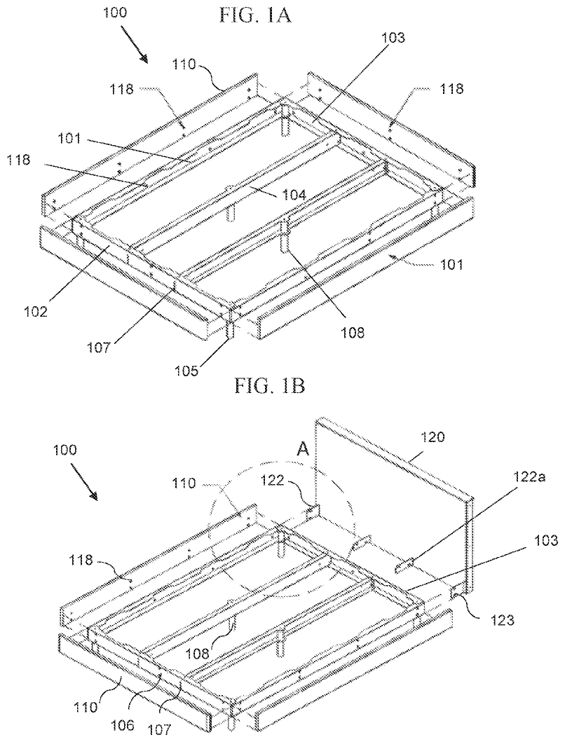

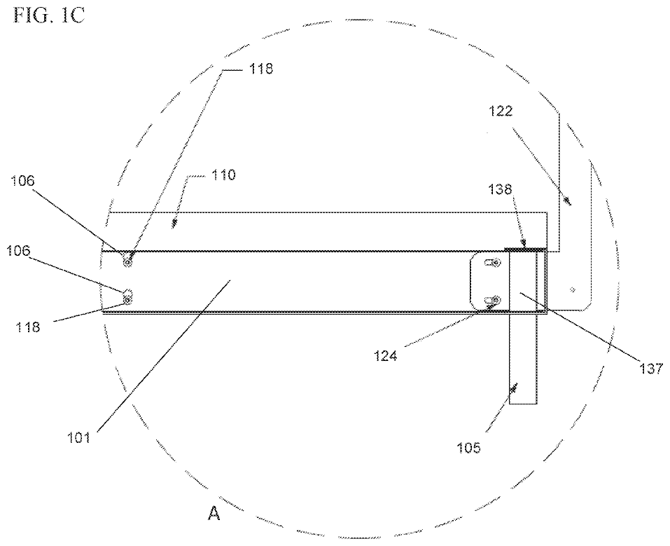

A first aspect of the invention is described in relation to FIG. 1A, providing a modular bed base (100), comprising: a frame (109) configured from a front rail (102), a back rail (103) and a pair of side rails (101); a support member illustrated as centre rail (104) configured to engage with and span the frame (109); and a plurality of interchangeable cladding panels (110) adapted to at least partially cover the frame (109), wherein at least one of the front rail (102) and the pair of side rails (103) comprise a plurality of mounting features (106), configured to engage with a plurality of co-operating mounting features (118) of the plurality of interchangeable cladding panels (110) to releasably mount the cladding panels (110) to a periphery of the frame (109).

FIG. 1A illustrates the modular bed base (100) with cladding panels (110) according to an embodiment of the invention. The cladding panels (110) provide a plurality of co-operating mounting features (118) for engaging with mounting features (106) of the bed frame (109).

At least one centre rail (104) is provided between the side rails (101) to strengthen the frame (109) of the modular bed base (100). In an embodiment, the modular bed base (100) includes no centre rail (104). In another embodiment, the modular bed base (100) includes one or more centre rails (104). A plurality of legs (105) is attached to the frame (109) to elevate the modular bed base (100) from a floor or substrate supporting the modular bed base (100). The legs (105) are mounted to the frame (109) towards the periphery thereof at leg mounting points. Each leg mounting point is defined by a pair of aligned apertures in upper and lower flanges of the rail (101, 102, 103) such that a leg or operative leg portion can be threaded through the rail (101, 102, 103). In one embodiment, a leg (105) is located at each intersection of a rail (101, 102, 103) placing four legs (105) at each of the corners or apexes of the frame (109). Each leg mounting point can provide an internally threaded spacer (137) affixed to the rail (101, 102, 103). The spacer (137) can be welded to the upper and lower flanges of the rail (101, 102, 103) or alternatively adhered thereto, for example using an adhesive or mechanical locking arrangement.

In some embodiment, the frame (109) further comprises supplementary legs (108) supporting the at least one central rail (104) and elevating the rail (104) above the floor.

FIG. 1B illustrates a modular bed base (100) with cladding panels (110) and a bedhead (120) according to an embodiment of the invention. The back rail (103) and optionally the front rail (102) further comprise one or more slots (107) to receive mounting brackets (122) of a bedhead (120). The mounting brackets (122) are inserted into the slots (107) and the bed head (120) is guided into place abutting the back rail (103) of the frame (109). The bed head (120) can have two mounting brackets (122). The bed head (120) can have three mounting brackets (122). The bed head (120) can have four mounting brackets (122). Each mounting bracket (122) has at least one aperture (123) for securing the bracket (122) in place in relation to the frame (109).

The bedhead (120) of FIG. 1B is configured to be attached to the back rail (103) through the mounting brackets (122). For example, as illustrated in FIG. 1B, the bedhead brackets (122) are configured to be slotted into the bed frame (109) behind the legs (105), and central bedhead brackets (122a) are configured to be slotted into the back rail (103) and are bolted into the centre rails (104) via apertures (123).

FIG. 1C is an enlarged view of a portion of the bed base frame as illustrated in FIG. 1B. The bed cladding panels (110) are bolted into keyholes (106) of the side rails (101). Some bolts (124) are first removed from the bed cladding panels (110) and then reinserted through the bedhead brackets (122) to secure the bedhead (120). However, the bedhead brackets (122, 122a) can be provided separately to the bedhead (120) in another embodiment. In some embodiments of the modular bed base (100) the bedhead brackets (122) are substituted for struts (not illustrated).

The frame (109) has a plurality of mounting features (106) for engaging with the cladding panels (110). FIGS. 1A-1C illustrate the mounting features (106) as keyholes on the rails (101, 102, 103). For example, each of the side rails (101), the front rail (102) and the back rail (103) have one or more keyholes on an outer facing surface (112) as illustrated in FIG. 1C. The keyholes (106) allow bed cladding panels (110) to be attached to the modular bed base (100) from outside of the frame (109).

Turning to FIG. 1C, each cladding panel (110) provides at least one cooperating mounting feature (118) to cooperate with a corresponding mounting feature (106) of the frame (109). Each cooperating mounting feature (118) can be comprised of a threaded insert (127) for receiving a bolt (124). The bolts (124) have an enlarged head, for example dome heads and can be selected from sizes M6-M10 and preferably a size of M8 (8 mm in diameter) or other desirable size. Each threaded insert (127) of the cladding panel (110) supports a bolt (124) threaded therein such that the oversized head of the bolt (124) is inserted through the keyhole (106) to engage the cladding panel (110) with the corresponding mounting feature (106) of the rail (101, 102, 103). The bolts (124) are threaded through the keyhole and slotted into place. From this engaged position, the bolts (124) can be tightened from inside the frame (109) against the rails (101, 102, 103) once the cladding panels (110) are in place.

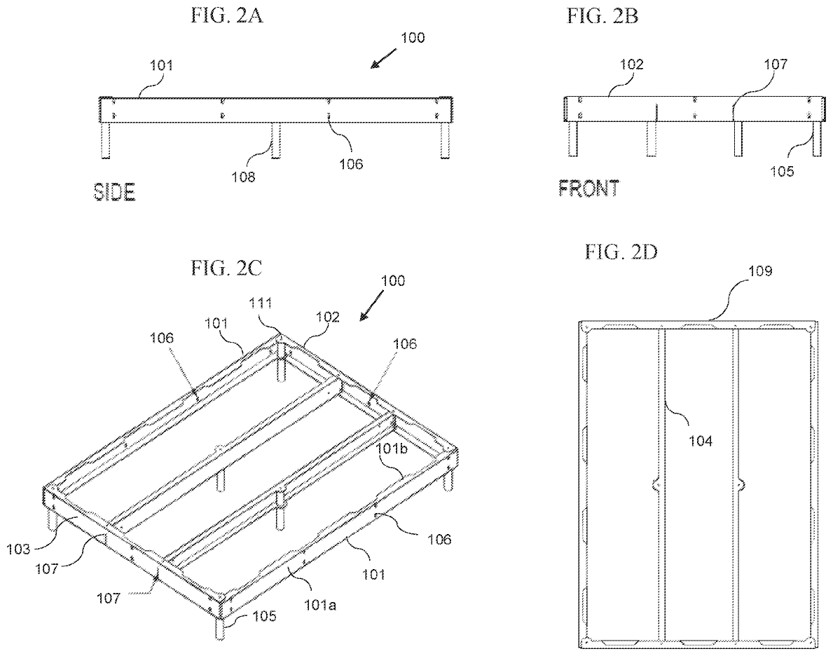

FIGS. 2A-2D illustrate side, front, isometric and top views of the modular bed base (100) according to an embodiment of the present invention. FIG. 2A is a side view of the modular bed base (100), and FIG. 2B is a front view of the modular bed base (100) illustrating pairs of mounting features (106) at regular spaced intervals along the side (101) and front (102) rails. Mounting slots (107) are arranged between the pairs of mounting features (106) to receive the brackets (122) of the bedhead (120).

As illustrated in FIG. 2C, the modular bed base (100) has a frame (109). For example, the frame (109) can include two side rails (101), a front rail (102), a back rail (103) and two centre rails (104). The frame (109) can be manufactured from: steel; aluminium; solid wood such as hardwood; engineered wood such as plywood; and combinations thereof.

The side rails (101), the front rail (102), the back rail (103) and two centre rails (104) are connected together by fasteners or bolts (111). The side rails (101) are equal in length or longer than the front rail (102) and the back rail (103) in an embodiment. However, the side rails (101) may be equal to or shorter than the front rail (102) and the back rail (103) in another embodiment. The front rail (102) is the same or substantially the same length as the back rail (103).

FIG. 2D illustrates the frame (109) in top or plan view. The rails (101, 102, 103) can be seen to have a series of cut-outs or scallops (116) atop the frame (109). These scallops (116) are trapezoidal in shape and reduce the weight of each rail (101, 102, 103). Additionally, the scallops (116) can be used for interlocking additional components to the frame (109). Each rail (101, 102, 103) is a substantially C-shaped cross-section, having two parallel flanges (101a) joined by a longer, central web (101b). The scallops (116) to not extend into the central web (101b) and extend only through the flanges (101a).

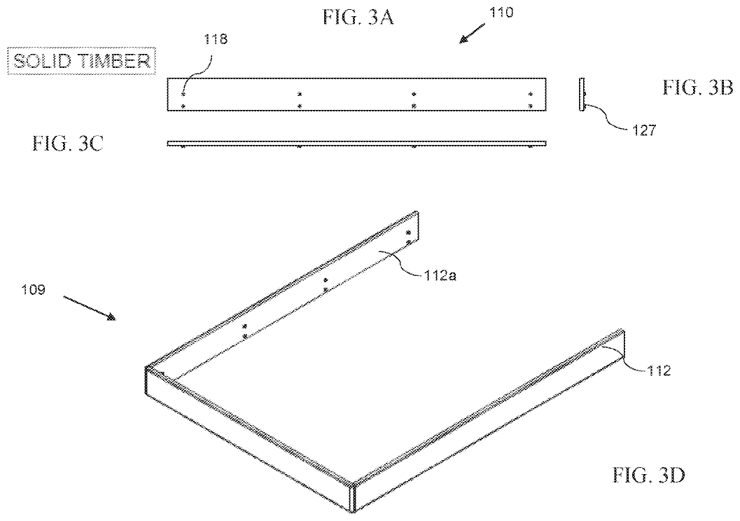

FIGS. 3A-3D illustrate different views of a plurality of interchangeable cladding panels (110) according to a first theme. FIG. 3A illustrates a side view of a planar cladding panels (110). The planar cladding panel (110) can be made of wood, solid wood, wood veneer or other desirable material.

FIG. 3B is an end view of the cladding panel (110) illustrating cooperating mounting features (118) in the form of threaded inserts (127) for receiving bolts (124) for mounting the panel (110) to the frame (109). FIG. 3C is a top view of cladding panel (110) again showing the inserts (127) protruding from a mounting face (112a) of the cladding panel (110).

FIG. 3D is a perspective view of three planar cladding panels (110) corresponding in length to the side (101) and front (102) rails of the frame (109) to which they are to be attached. No cladding panel (110) is configured from the rear rail (103) which is to receive a bed head (120). However, in embodiments where a bed head (120) is not selected, a fourth cladding panel (110) is added to FIG. 3D to completely cover the frame (109) with cladding panels (110).

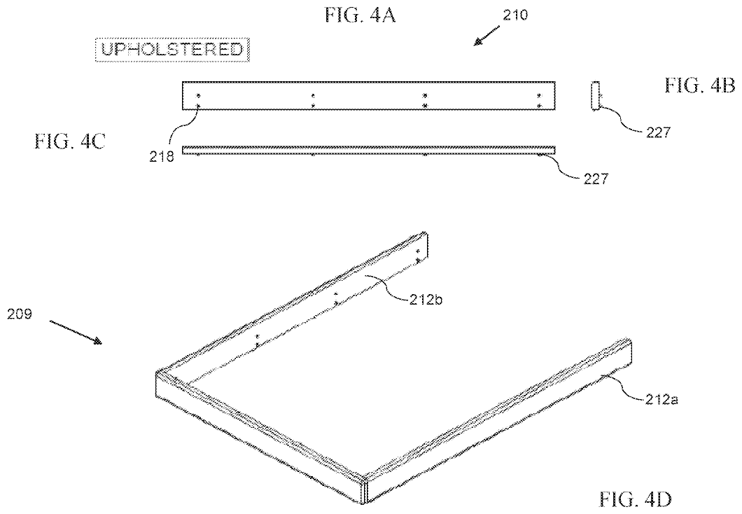

FIGS. 4A-4D illustrate different views of a plurality of interchangeable cladding panels (210) according to a second theme. FIG. 4A illustrates a side view of a profiled cladding panel (210). The profiled cladding panel (210) can be formed from a flexible material, like rubber or foam or can be padded and/or upholstered including any one of a fabric layer, a leather layer, a solid wood panel, a veneer panel any combination thereof. These surfaces finishes and textures aesthetically enhance the visible or outer surface (112a) of the cladding panels (210).

FIG. 4B is an end view of the cladding panel (210) illustrating cooperating mounting features (218) in the form of threaded inserts (227) for receiving bolts (124) for mounting the panel (210) to the frame (109). FIG. 4C is a top view of cladding panel (210) again showing the inserts (227) protruding from a mounting face (212b) of the cladding panel (210).

FIG. 4D is a perspective view of three planar cladding panels (210) corresponding in length to the side (101) and front (102) rails of the frame (109) to which they are to be attached. No cladding panel (210) is configured from the rear rail (103) which is to receive a bed head (120). However, in embodiments where a bed head (120) is not selected, a fourth cladding panel (210) is added to FIG. 4D to completely cover the frame (109) with cladding panels (210).

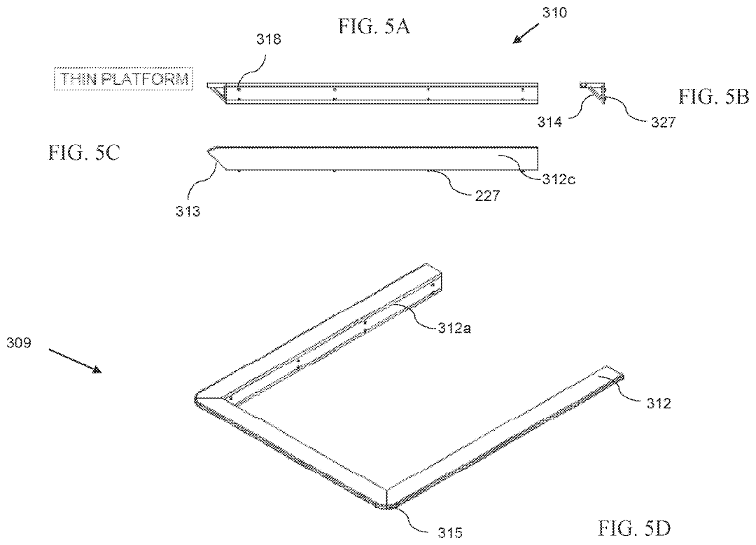

FIGS. 5A-5D illustrate different views of a plurality of interchangeable cladding panels (310) according to a third theme. FIG. 5A illustrates a side view of a thin platform cladding panel (310). The thin platform cladding panel (310) has an extended top surface (312c) and a support (314) provided to support the extended top surface (312c) of the thin platform cladding panels (310).

The described designs and styles of external bed cladding panels (110, 210, 310) are merely examples and do not limit the scope and make-up of the external cladding panel styles. For example, the external bed cladding panels may be upholstered in storage style, in platform style, timber style, steel style or any combination thereof.

FIG. 5A illustrates a side view of the thin platform cladding panel (310). The profiled cladding panel (310) can be formed from a hard wood, or engineered wood, or a metal or plastic material. Additionally the cladding panel (310) can be padded and/or upholstered including any one of a fabric layer, a leather layer, a solid wood panel, a veneer panel any combination thereof.

FIG. 5B is an end view of the cladding panel (310) illustrating cooperating mounting features (318) in the form of threaded inserts (327) for receiving bolts (124) for mounting the panel (310) to the frame (109). FIG. 5B also illustrated the top panel (312c) of the cladding panel (310) supported by the cladding support (314) which forms a right angle with the mounting face (312b) of the cladding panel (310).

FIG. 5C is a top view of cladding panel (210) again showing the inserts (227) protruding from a mounting face (212b) of the cladding panel (210). The cladding panel (310) has 45-degree angles cut into at least one end of the top panel (312c) to allow a pair of adjoining cladding panels (310) to abut and form a continuous perimeter around the frame (109). On the outer perimeter of the cladding panels (310) are rounded edges (315) providing a smooth outer profile to the cladding panels (310) when abutted around the frame (109). This reduces sharp corners and edges for users to bang their limbs against.

FIG. 5D is a perspective view of three planar cladding panels (310) corresponding in length to the side (101) and front (102) rails of the frame (109) to which they are to be attached. No cladding panel (310) is configured from the rear rail (103) which is to receive a bed head (120). However, in embodiments where a bed head (120) is not selected, a fourth cladding panel (310) is added to FIG. 5D to completely cover the frame (109) with cladding panels (310).

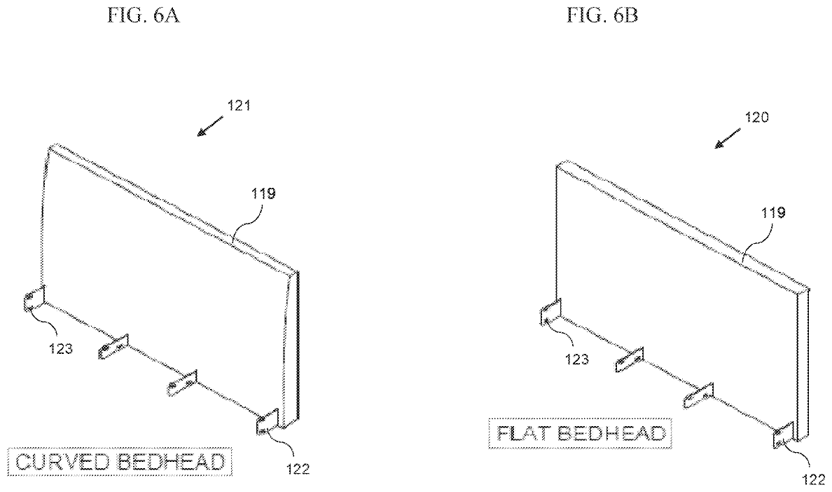

FIG. 6A illustrates a curved bedhead (121), and FIG. 6B illustrates a flat bedhead (120). Each bed head (120, 121) provides a plurality of mounting brackets (122) having at least one aperture (123) each. The brackets (122) are evenly spaced across a lower portion of the bed head (120, 121) such that the brackets (122) can mate with the frame (109) without being visible to a user. The brackets (122) are sufficiently long to extend through the back rail (103) of the frame (109) and can be bolted or otherwise secured to either the frame (109) or a central rail (104) to secure the bed head (120, 121) thereto.

Although not illustrated the bed heads (120,121) like the cladding panels (110, 210, 310) can be formed from a hard wood, or engineered wood, or a metal or plastic material. Additionally, the bed head (120, 121) can be padded and/or upholstered including any one of a fabric layer, a leather layer, a solid wood panel, a veneer panel any combination thereof.

It should also be understood that the designs and shapes of the bedheads as illustrated in FIGS. 6A and 6B are merely examples. The bedheads (120, 121) can have other desirable designs, styles and shapes in another embodiment.

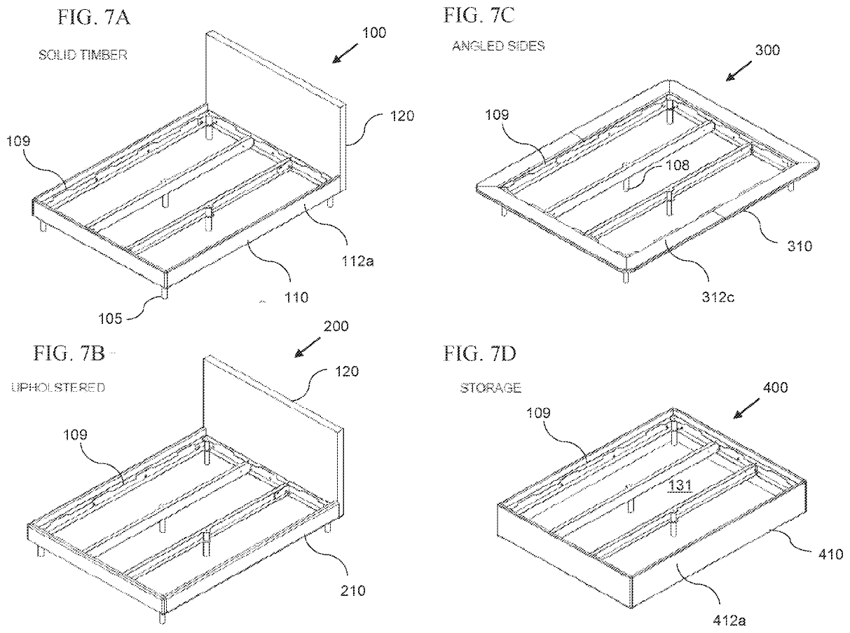

FIG. 7A illustrates the modular bed base (100) having the frame (109) adorned with solid timber bed cladding panels (110) according to the first theme and the flat bedhead (120). The bedhead (120) can be interchanged for a curved bedhead (121). The cladding panels (110) have the outer surface (112a) as the aesthetic surface and the inner surface (112b) as the mounting surface that abuts the frame (109). The outer surface (112a) extends partially over the modular bed base (100) covering the periphery of the frame (109) in combination with the bedhead (120) but not extending so far as to obscure or cover the legs (105) of the modular bed base (100). The bed head (120) is dimensioned to extend across a full width of the frame (109) and two cladding panels (110), to thereby mount flush with the outer surfaces (112a) of the cladding panels (110).

FIG. 7B illustrates the modular bed base (200) having the frame (109) adorned with upholstered bed cladding panels (210) according to the second theme and a bedhead. The upholstered cladding panels (210) can include a fabric layer, a leather layer, a solid wood panel, a veneer panel or combination thereof. The bedhead (120) can be interchanged for a curved bedhead (121). The cladding panels (210) have the outer surface (212a) as the aesthetic surface and the inner surface (212b) as the mounting surface that abuts the frame (109). The outer surface (212a) extends partially over the modular bed base (200) covering the periphery of the frame (109) in combination with the bedhead (120) but not extending so far as to obscure or cover the legs (105) of the modular bed base (200). The bed head (120) is dimensioned to extend across a full width of the frame (109) and two cladding panels (210), to thereby mount flush with the outer surfaces (212a) of the cladding panels (210).

FIG. 7C illustrates the modular bed base (300) having the frame (109) adorned with angled bed cladding panels (310) according to the third theme to form a thin platform around the frame (109). The angled bed cladding panels (310) have extended top surfaces (312c) creating a platform around the frame (409). The cladding panels (310) have the upper surface (312c) as the aesthetic surface and the inner surface (312b) as the mounting surface that abuts the frame (109). The upper surface (312c) extends entirely around the modular bed base (300) covering the periphery of the frame (109) entirely but not extending so far as to obscure or cover the legs (105) of the modular bed base (300).

FIG. 7D illustrates the modular bed base (400) having the frame (109) adorned with storage bed cladding panels (410) according to a fourth theme. The storage cladding panels (410) have extended side surfaces (412a) dimensioned to cover the frame (109) and legs (105) and to render them unseen beneath the cladding (410). The storage cladding panels (410) enclose the frame (409) and form a storage space (131) therein. The cladding panels (410) have the outer surface (412a) as the aesthetic surface and the inner surface (412b) as the mounting surface that abuts the frame (109). The outer surface (312a) extends entirely around the modular bed base (300) covering the periphery of the frame (109) entirely and extending so far as to obscure or cover the legs (105) of the modular bed base (400).

The different styles of the cladding panels (110, 210, 310, 410) as illustrated in FIG. 7A-7D can be interchangeably used with the frame 109 and bed heads (120, 121). The frame (109) is an adaptable frame having a universal steel central core, in one embodiment of the invention.

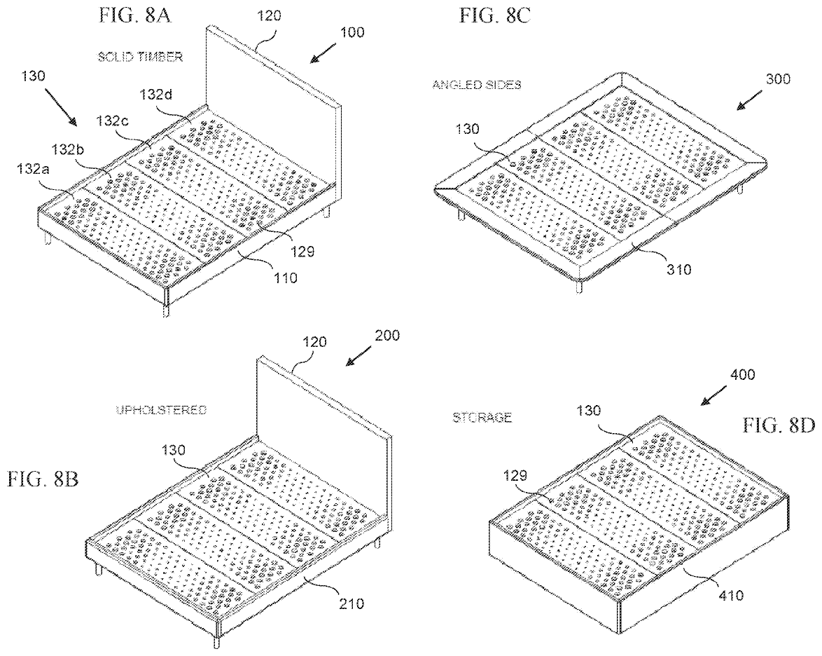

FIG. 8A to FIG. 8D illustrate designs of modular bed base (100) with different interchangeable bed cladding panels and a support platform, according to embodiments of the invention.

For example, FIG. 8A illustrates a modular bed base (100) having a frame (109) adorned with solid timber bed cladding panels (110), a support platform (130) and a bedhead (120). The bedhead (120) can be substituted for a curved bedhead (121). The support platform (130) is provided atop the frame (109) to support a mattress thereon. The support platform (130) can be formed of four identical platform modules (132a-d).

A plurality of cut-outs or aeration holes (129) are provided on each of the platform modules (130) to increase breathability and airflow from the bottom of the frame (109). The platform modules (130) have straight edges as illustrated in FIG. 8A and abut with one another in side-by-side arrangement atop the frame (109).

FIG. 8B illustrates a modular bed base (200) having a frame (109) adorned with upholstered cladding panels (210), a support platform (130) and a bedhead (120). The upholstered cladding panels (210) can include a fabric layer, a leather layer, a solid wood panel, a veneer panel or combination thereof. The support platform (130) comprises the same four identical platform modules (132a-d) as the support platform (130) shown and described in reference to FIG. 8A.

FIG. 8C illustrates a modular bed base (300) having a frame (109) adorned with angled bed cladding panels (310) and a support platform (130). The angled bed cladding panels (310) have extended top surfaces (312c) around the frame (109) as described above. The support platform (130) has the same modular four-piece constructions as the support platform (130) shown and described in reference to FIG. 8A.

FIG. 8D illustrates a modular bed base (400) having a frame (109) adorned with storage cladding panels (410) and a support platform (130). The storage cladding panels (410) have extended side surfaces (412a) and cover an outside of the frame (109) and legs (105) entirely. The storage cladding panels (410) enclose the frame (109) and form a storage space (131) therein. The support platform (130) has the same modular four-piece constructions as the support platform (130) shown and described in reference to FIG. 8A.

All the different types of the cladding panels as illustrated in FIGS. 3A-3D, FIGS. 4A-4D and FIG. 5A-5D are interchangeable with each other and can be selectively attached and detached with the frame (109). Users can easily change the visual appearance and configuration of the modular bed base (100, 200, 300, 400) based on their preference.

The cladding panels (110, 210, 310, 410) can be attached to the frame (109) through but not limiting to a keyhole (106) and bolt (124) connection as described above. The mounting feature (106) and co-operating mounting features (118) can be selected from any one of the following: slots, keyholes, apertures, bosses, tabs, dimples, pegs, hooks, bolts and dowels.

The cladding panels (110, 210, 310, 410) can also be attached to the frame (109) through other desirable attachment mechanisms such as magnetic attachment mechanisms, overhanging attachment mechanisms and/or hook-on attachment mechanisms. In a magnet attachment mechanism, for example, a plurality of magnets are attached and/or integrated into the bed cladding panels (110, 210, 310, 410), thus allowing the cladding panels to be easily attached to a universal bed base frame such as a core steel frame. (109).

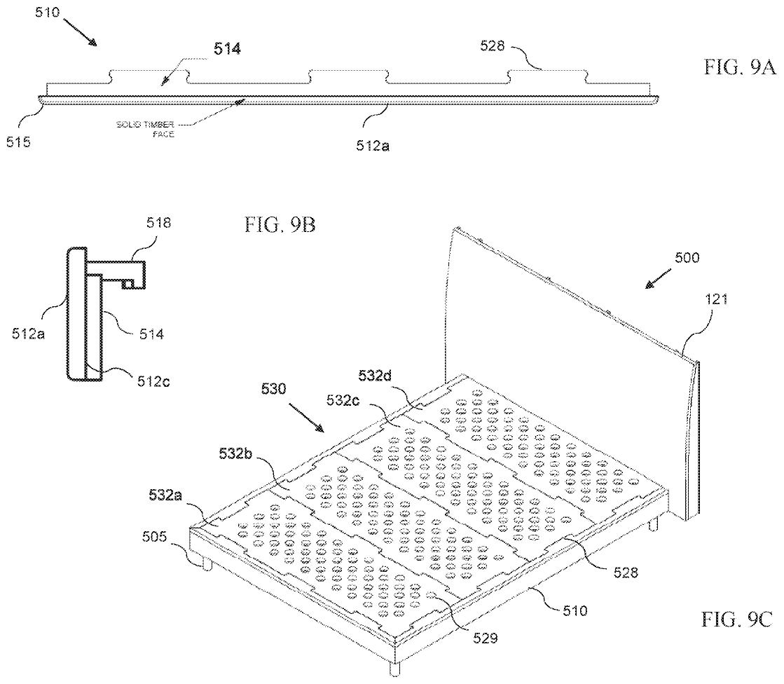

FIG. 9A to FIG. 9C illustrate an overhanging cladding panel (510) attachment mechanism according to an embodiment, providing a fifth theme. FIG. 9A is a top view of a cladding panel (510) having a face or outer surface (512a) a cladding support (514) and a cooperating mounting feature in the form of a hanger (518). The outer surface (512a) can be selected from a solid timber panel, a platform panel, an upholstered panel, a storage panel and any other desirable panel. The cladding support (514) can be rigid or resilient to space the cladding (510) from the frame (109) and hold the cladding in position around the frame (109) so that the cladding doesn't move, slide, creak or swing.

The hanger (518) has a castellated edge pattern (528), or any other desirable interlocking pattern to allow the hanger (518) of the cladding panel (510) to clip and/or lock over the top of the bed frame (109) and interleave with the support platform (530). The outer surface (512a) is attached to the hanger (518) by glue, bolts or similar fasteners. In some embodiments the hanger (518) and outer surface (512a) can be integrally formed before the outer surface is upholstered. The cladding support (514) can also be joined with an inner surface (512c) of the cladding panel (510) by glue, bolts or similar fasteners. The hanger (518) can be made of solid wood such as hardwood, engineered wood such as plywood, steel or any other desirable material.

FIG. 9B is a side view of the cladding panel (510) illustrating an L-shaped cross-section, where the hanger (518) sits atop the frame (109) and the outer surface (512a) falls over a side of the frame (109) to hide the frame (109) from view. FIG. 9C illustrates an example of a modular bed base (500) with cladding panels (510) attached by an overhanging attachment mechanism. The cladding panels (510) can have other designs and styles not limiting to platform panels, upholstered panels and storage panels that can be attached to the universal bed base frame by the overhanging attachment mechanism. Shown in FIG. 9C, the support platform (530) comprises a plurality of platform modules (532a-c) having matching edge castellations to interleave with the cladding panels (510), when mounted around the frame (109).

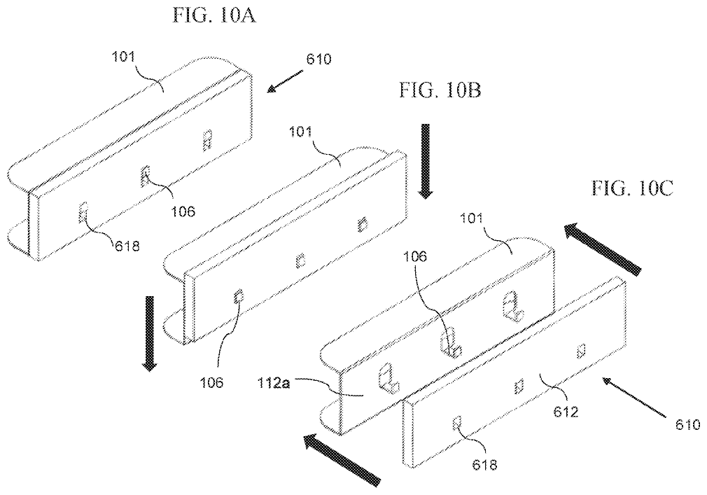

FIG. 10A illustrates a hook-on cladding panel (610) according to an embodiment. Best illustrated in FIG. 10C, a plurality of mounting features (106) illustrated as hooks are formed on the outer surface (112a) of a side rail (101) of the frame (109).

The hook-on cladding panel (610) can be easily attached to the rail (101) via the hooks (106) formed on the outer surface (112a). The cladding panels (610) are provided with a plurality of apertures (618) for cooperating with the hooks (106) of the frame (109). Shown in FIG. 10C the cladding panel (610) is positioned in proximity to the rail (101) such that the plurality of apertures (618) are aligned with the plurality of hooks (106). The cladding panel (610) is mounted on the rail (101) by sliding each of the hooks (106) through the corresponding aperture (618) illustrated in FIG. 10B (see solid arrows indicating direction of movement). Finally, the cladding panel (610) is gently lowered onto the hooks (106) to secure the cladding panel (610) to the rail (101) and support the weight of the cladding panel (610) on the hooks (106) (again indicated by arrows showing movement in FIG. 10B). Without lifting the cladding panels (610) they cannot slip or fall from the rail (101), shown in FIG. 10C. The cladding panels (610) can be removed from the frame (109) in the opposite manner to the attachment steps described above, without damage or the need for tools or specialist knowledge or equipment.

Advantages of the hook-on attachment mechanism include a strong integrated attachment of the external cladding panel (610), easy assembly for the users and no extra parts requirement. The bed cladding panel (610) as illustrated in FIG. 10A-C can have different themes (designs and styles and textures eg. platform panels, upholstered panels, storage panels or any other desirable shapes and/or styles as described herein). The cladding panel (610) with different designs and styles can be attached in this manner to the universal bed base frame by the hook-on attachment mechanism.

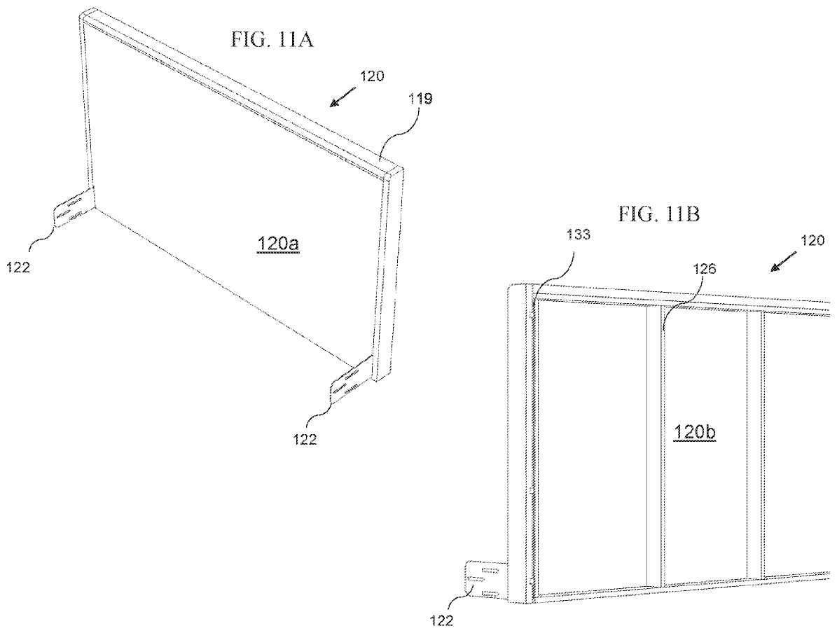

FIGS. 11A and 11B illustrate the bed head and bed head mounting in more detail. The bed head (120) comprises a support panel or headboard (119) and a pair of bed head mounting brackets (122). The bed head (120) is mounted via the pair of bed head mounting brackets (122) (and possibly more). A bed facing surface (120a) of the bed head (120) mounts to the bed frame (109) while the brackets (122) are inserted into the headboard (119) of the bed head (120) from a wall facing surface (120b) of the bed head (120). A housing or sheath (133) is formed in the wall facing surface (120b) of the bed head (120) which receives and supports the brackets (122). This provides for a solid and sturdy connection between the bed head (120) and the bed frame (109). One or more upright bed heat supports (126) can also be incorporated into the headboard (119) of the bed head (120) to increase stability of the bed head (120) and in some embodiments to support and secure additional bed head mounting brackets (122) not shown in FIGS. 11A and 11B.

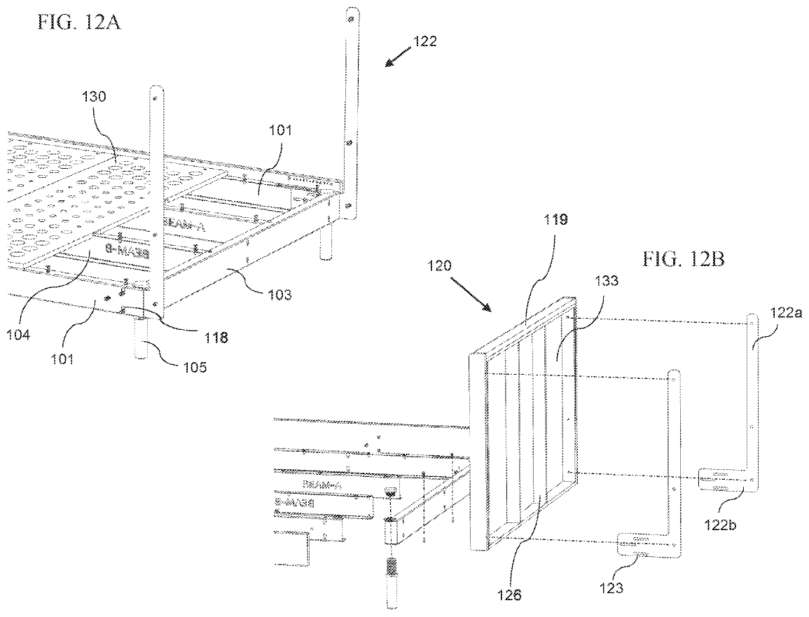

FIGS. 12A and 12B illustrate the connection between the bed frame (109) and the brackets (122) in more detail, FIG. 12A having the headboard (119) removed for clarity. The bracket (122) is L-shaped having a tall vertical portion (122a) and a shorter horizontal portion (122b). Apertures (123) are formed in each of the vertical and horizontal portions (122a, 122b) for securing the bracket (122). The side rails (101) of the frame (109) provide corresponding mounting features (118) for engaging with the apertures (123) in the horizontal portion (122b) via bolts/screws/rivets or similar fasteners. The brackets (122) are slid into the corresponding sheath (133) from the wall facing surface (120b) and secured thereto via additional apertures (123) towards an upper portion of the bed head (120). Once the brackets (122) are secured to the headboard (119), the bed head (120) can be mounted to the frame (109). As the vertical portion (122a) extends to the full height of the headboard (119) and is mounted directly into the frame (109), the assembled bed head (120) is rigid and strong and can withstand people leaning on it, and children climbing on it. The vertical portion (122a) of the bracket (122) is concealed within the sheath (133) of the headboard (119), thus hidden from view and protected from snagging.

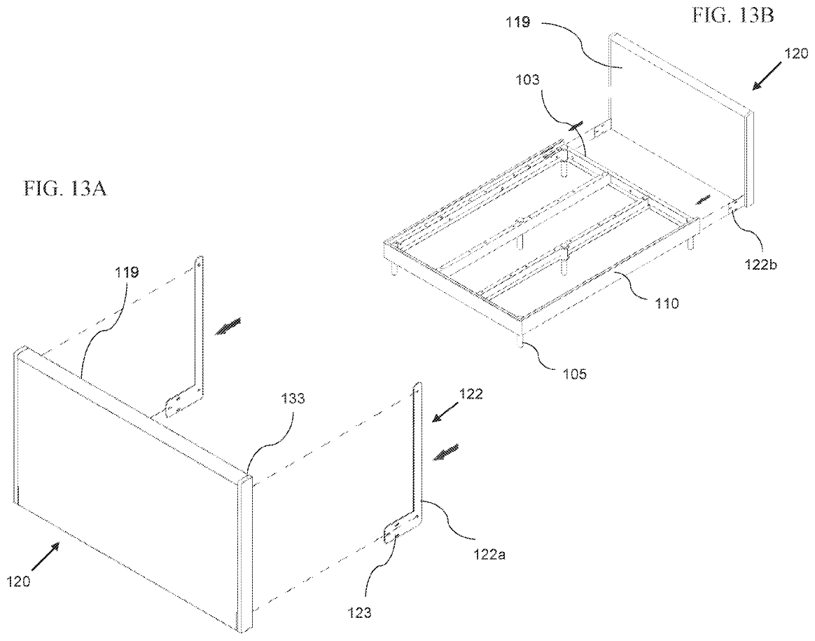

FIGS. 13A and 13B illustrated the steps of mounting the bed head (120) to the frame (109) by virtue of black arrows illustrating a direction of movement. A similar mounting strategy is used for the curved bed head (121) although not illustrated herein in detail. As the bed-head brackets (122) are not located at the edges of the headboard (119) the bed head (120) sides sit flush with the cladding panels (110) of the bed base (100) providing a snag free and aesthetically uncluttered appearance.

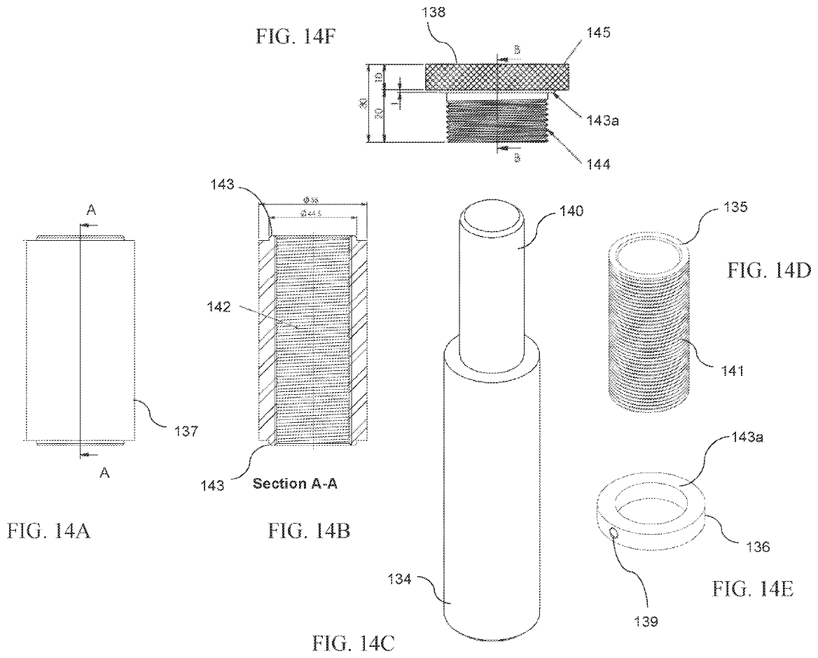

The bed leg assembly (105) and alternative embodiments thereof will be explained in more detail in relation to FIGS. 14-23.

FIGS. 14A-14F illustrate components of a bed leg assembly (105) according to one embodiment of the invention. A spacer (137) is located into the C-Section of the bed rails (101) at the intersecting corner portions between the front and rear rails (102, 103). Each of the rails provides a series of circular apertures (152) located towards the opposing ends of each rail. When two rails are brought together at right angles, the apertures (152) therethrough are aligned to form a bed leg mounting. The apertures (152) at the top and bottom of the bed leg mounting are connected with the spacer (137) which is sized to fit snuggly into the C-section of the rails (101, 102, 103). The spacer (137) has an internal thread (142) and an upper and lower seat (143). The lower seat configured to engage with a seat (143a) of a collar (136) and the upper seat (143) configured to engage with a button (138). The internal thread (142) and seats (143) are illustrated in cross-section in FIG. 14B. The internal thread (142) can be an M39 thread providing a strong and sturdy attachment for the bed leg assembly (105) to the bed base (100).

A foot (134) of the leg assembly (105) is configured to mount within the spacer (137) and is the only visible element of the leg (105) in the assembled form. The foot (134) can be formed from metal, plastic or similar material, whereas the foot (134) illustrated in FIG. 14C is made from wood. The foot (134) has a thick lower portion to provide a sturdy base to the foot (134) and a narrower upper portion in the form of a dowel (140). The dowel (140) is smooth and formed to receive an externally threaded sleeve (135) illustrated in FIG. 14D. The sleeve (135) is crimped or otherwise fitted to the dowel (140) to become permanently engaged with the foot (134). Where the foot (134) is formed from metal, the external thread (141) can be formed integrally on the foot (134). To assemble the leg (105) the foot (134) and sleeve (141) are screwed into the spacer (137) from below the bed frame (109). The collar (136) is seated on the dowel (140) below the sleeve (135) and can be tightened against the sleeve by a grub screw or lock screw (139) from the exterior of the leg (105). This will hold the foot (134) in place in relation to the spacer (137), illustrated in FIG. 14E.

Once the leg (105) is fitted to the bed base (100) and tightened, the button (138) is secured in place to seal the upper opening of the spacer (137). The button (138) comprises a threaded stem (144), that screws into the upper opening of the spacer (137) providing a smooth upper surface to the bed leg mounting along the rails (101, 102, 103). The button (138) can have a knurled outer surface (145) or similar for improved grip facilitating locating and screwing the button (138) into position in the leg assembly (105). An underside of the button (138) provides a cooperating seat (143a) for engaging with the upper seat (143) of the spacer (137).

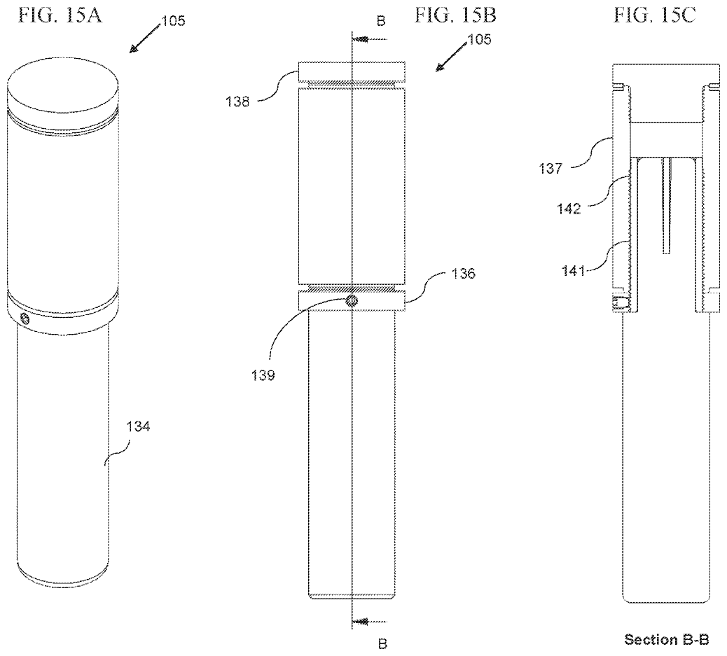

The assembled leg (105) is illustrated in FIGS. 15A-15C, independent of the bed frame (109). FIG. 15B illustrates the front of the leg (105) and a section line B-B is taken down a primary axis of the leg (105) centrally thereto. The section B-B of FIG. 15C illustrates the interconnection between the external thread (141) of the sleeve (135) and the internal thread (142) of the spacer (137). The threaded M39 connection provides a solid connection between the leg (105) and the frame (109) sufficient to support the bed base (100) and the weight of a mattress and occupants thereon. The M39 connection is also strong enough to counter shear loads placed onto the bed legs (105) and minimise any lateral movement or creaking under load.

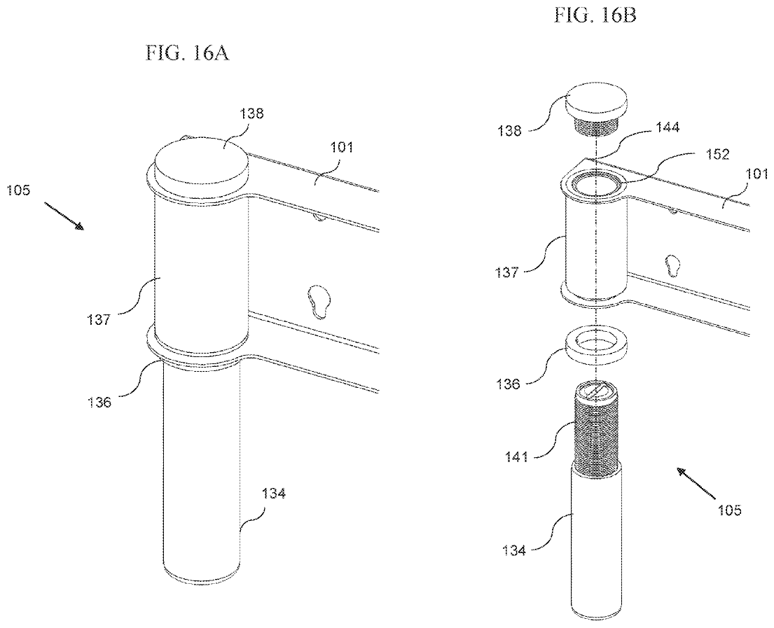

A cut-away view of the leg (105) about the rail (101) is shown in FIGS. 16A and 16B both assembled and exploded. The button (138) is applied to the leg assembly (105) from above the frame (109) while the foot (134) and integrated sleeve (141) are inserted from below the frame (109) trapping the spacer (137) therebetween to be locked in position with the collar (136).

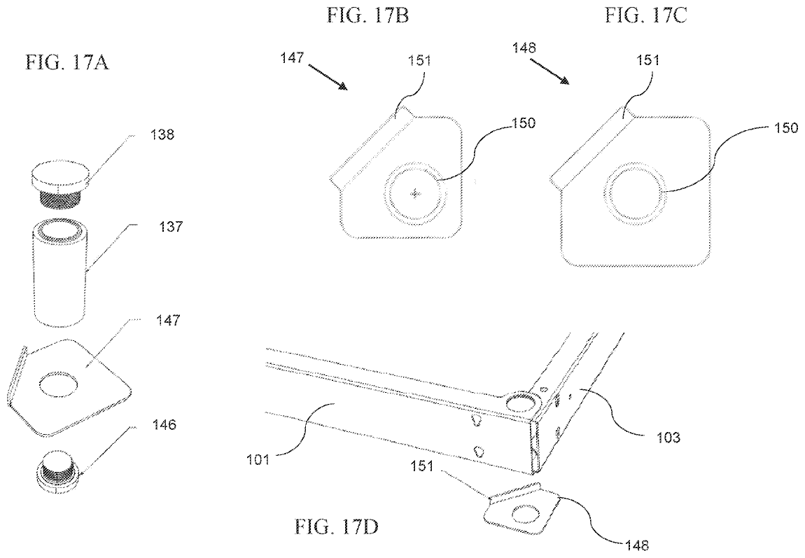

Alternative leg assemblies can be mounted via a foot plate, as described in reference to FIGS. 17A-17D. The foot plate (147) provides a right-angled side portion for abutting the internal faces of the rails (101, 102, 103) and opposing the right-angled side portion is a locking flange (151). The locking flange (151) is formed from an upturned portion of the foot plate (147) and locks the foot plate (147) into position against the frame (109).

Centrally located within the foot plate (147) of FIG. 17B is a circular aperture (150) for receiving the foot (134) as described in relation to leg assembly (105). Alternatively, the foot plate (147) can have a foot welded or otherwise connected or formed thereon. Where a foot is mounted directly to the foot plate (147) a spacer (137) can be inserted internally of the rails (101, 102, 103) of the frame (109) and a closer illustrated as a button (138) used to seal the upper aperture of the spacer (137). A cap or lower button (146) can also be used to seal the aperture (150) at a lower end of the spacer (137).

In some embodiments the spacer (137) can be welded or otherwise fixed to the frame rails (101, 102, 103) removing the need for the button (138) and the lower button (146). In these embodiments the foot (134) is screwed directly into the spacer (137) from beneath the frame (109) and the collar (136) is used to lock the foot (134) in place.

An alternative, larger, foot plate (148) is illustrated in FIG. 17C providing a greater surface area for attaching different feet thereto. Centrally located within the large foot plate (148) is a circular aperture (150) for receiving a foot (134) as described in relation to leg assembly (105). Alternatively, the large foot plate (148) can have a foot welded or otherwise connected or formed thereon. Where a foot is mounted directly to the large foot plate (148) a spacer (137) can be inserted internally of the rails (101, 102, 103) of the frame (109) and the button (138) used to seal the upper aperture of the spacer (137). The lower button (146) can also be used to seal the aperture (150) at a lower end of the spacer (137). The spacer (137) is thus clamped between the upper button (138) and the lower button (146) clamping the foot plate (147,148) against an underside of the bed frame (109) and tensioning the foot plate (147, 138) against the frame (109).

As each button (138, 146) is turned against the internal thread (142) of the spacer (137) the leg assembly (105) is tightened and tensioned against the frame (109) to reduce any movement or slack in the system and reduce any squeaks or noise from the bed base (100) when loaded. In some embodiments, the spacer (137) can be pre-joined or welded or adhered to the rail (101,102,103) prior to assembling the frame. This spacer (137) can then receive the foot (134) an upper button (138) and a lower button (146), where each button is screwed directly into opposing ends of the spacer (138). In some embodiments the upper button (138) is not used particularly where the spacer is pre-welded to the rails (101,102,103). In embodiments where the upper button (138) is not used to tension the leg assembly (105) against the frame (109) the button (138) can still be used as a sealing member to stop dust and foreign objects from falling into the spacer (137).

Each of the small foot plate (147) and the large foot plate (148) have the same features and form, but with differing dimensions to fit snuggly beneath the frame (109). A corner joint between the back rail (103) and a side rail (101) is illustrated in FIG. 17D where the large foot plate (148) is illustrated in alignment ready to be attached beneath the frame (109) via the dowel (140) of the leg assembly (105). The locking flange (151) is tightened between the two rails (103) and (101), forming a brace therebetween. In some embodiments the foot plates (147, 148) can be a thickness of 3 mm, or 4 mm, or 5 mm, depending on the weight requirements for the frame (109).

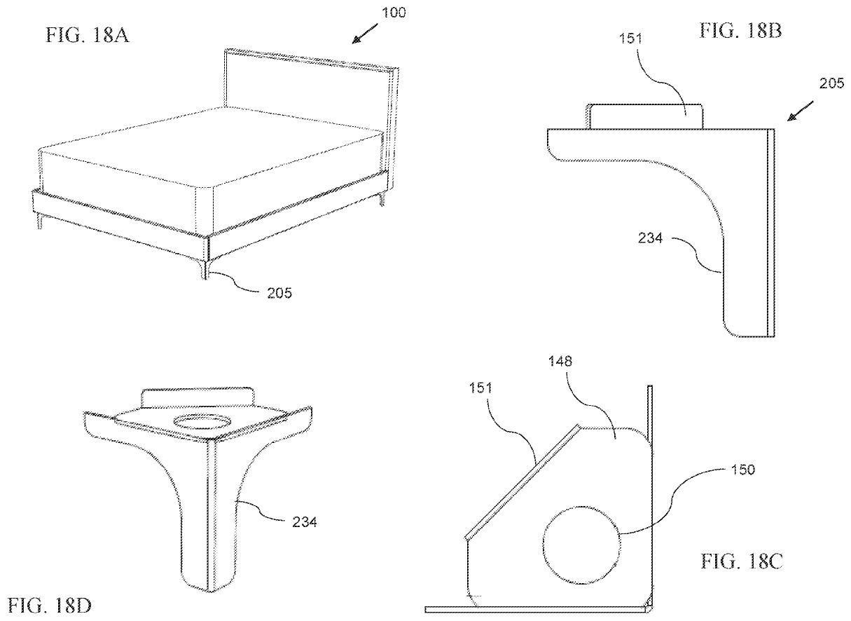

Alternative embodiments of leg (105) will be described in relation to FIG. 18-23, in which differing foot styles are welded or alternatively mounted to the large foot plate (148). The large foot plate (148) can be substituted for the smaller foot plate (147) without change to the description as follows.

FIGS. 18A-18D illustrate the bed base (100) with an ornamental leg assembly (205), where the ornamental leg (205) comprises the large foot plate (148) with an ornamental foot (234) welded thereto. This modular leg (205) can be selected to provide alternative aesthetics to the finished bed frame (100) and allow a user to customise the appearance of the frame (100). The leg assembly (205) can also be easily removed and replaced at any time where the user elects to change their decor and change the style of the frame (100). The leg assembly (205) provides the same foot plate (148) and locking flange (151) as described in relation to FIG. 17, while the foot (234) is curved, providing an arcuate shape on two exterior faces of the frame (109) once attached. The spacer (137) is internally positioned at the intersection of two rails, and each of the upper button (138) and the lower button (146) are screwed into the spacer (137) from opposing directions to located and tension the leg (205) to the frame (109).

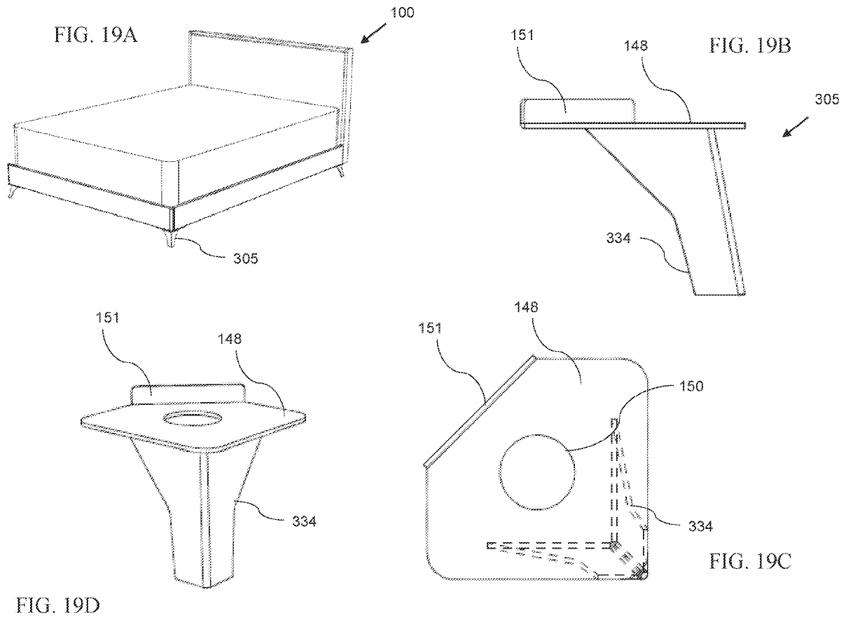

FIGS. 19A-19D illustrate the bed base (100) with an angled leg assembly (305), where the angled leg (305) comprises the large foot plate (148) with an angled foot (334) welded thereto. This modular leg (305) can be selected to provide alternative aesthetics to the finished bed frame (100) and allow a user to customise the appearance of the frame (100). The leg assembly (305) can also be easily removed and replaced at any time where the user elects to change their decor and change the style of the frame (100). The leg assembly (305) provides the same foot plate (148) and locking flange (151) as described in relation to FIG. 17, while the foot (334) is angled, providing an angular profile on two exterior faces of the frame (109) once attached. The spacer (137) is internally positioned at the intersection of two rails, and each of the upper button (138) and the lower button (146) are screwed into the spacer (137) from opposing directions to located and tension the leg (305) to the frame (109). The foot (334) is angled at about 15 degrees to the vertical.

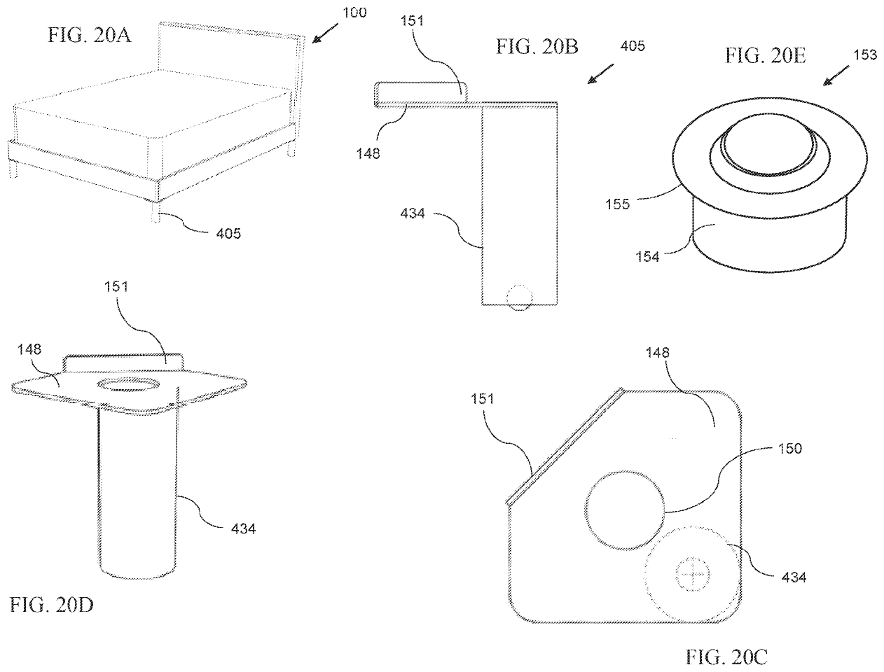

FIGS. 20A-20D illustrate the bed base (100) with a thick cylindrical leg assembly (405), where the thick cylindrical leg (405) comprises the large foot plate (148) with a thick cylindrical foot (434) welded thereto. This modular leg (405) can be selected to provide alternative aesthetics to the finished bed frame (100) and allow a user to customise the appearance of the frame (100). The leg assembly (405) can also be easily removed and replaced at any time where the user elects to change their decor and change the style of the frame (100). The leg assembly (405) provides the same foot plate (148) and locking flange (151) as described in relation to FIG. 17, while the foot (434) is cylindrical, providing a thick cylindrical profile once attached. The spacer (137) is internally positioned at the intersection of two rails, and each of the upper button (138) and the lower button (146) are screwed into the spacer (137) from opposing directions to located and tension the leg (405) to the frame (109).

FIG. 20E illustrates a castor (153) facilitating moving of the frame (109) across any surface on which the bed base (100) is supported. The castor (153) comprises a rolling element (155) captured in a mounting cup (154). While the rolling element (155) is illustrated as a ball it is contemplated that the rolling element could be a wheel. It is further contemplated that the mounting cup (154) could be replaced with an alternative housing for capturing and retaining the rolling element, while allowing it to freely roll therein.

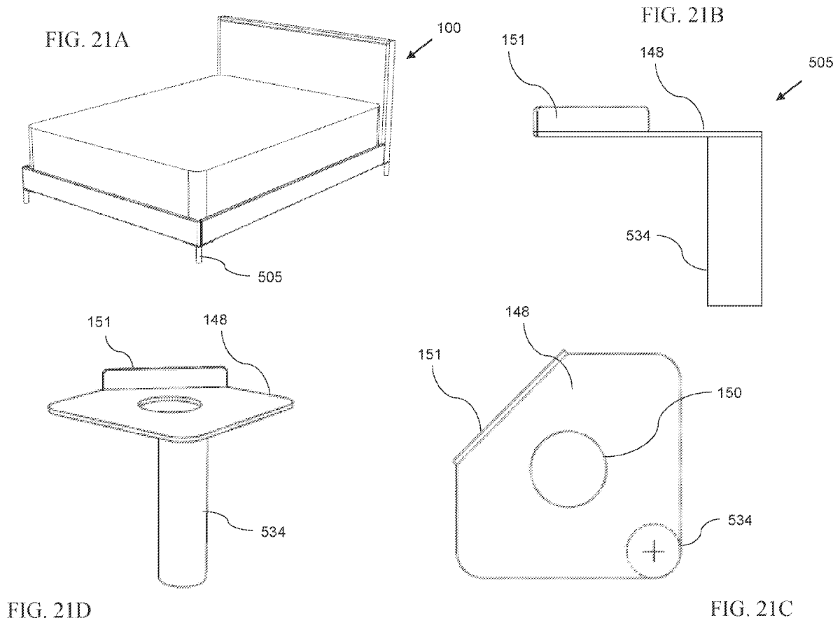

FIGS. 21A-21D illustrate the bed base (100) with a thin cylindrical leg assembly (505), where the thin cylindrical leg (505) comprises the large foot plate (148) with a thin cylindrical foot (534) welded thereto. This modular leg (505) can be selected to provide alternative aesthetics to the finished bed frame (100) and allow a user to customise the appearance of the frame (100). The leg assembly (505) can also be easily removed and replaced at any time where the user elects to change their decor and change the style of the frame (100). The leg assembly (305) provides the same foot plate (148) and locking flange (151) as described in relation to FIG. 17, while the foot (534) is cylindrical, providing a thin cylindrical profile once attached. The spacer (137) is internally positioned at the intersection of two rails, and each of the upper button (138) and the lower button (146) are screwed into the spacer (137) from opposing directions to located and tension the leg (505) to the frame (109).

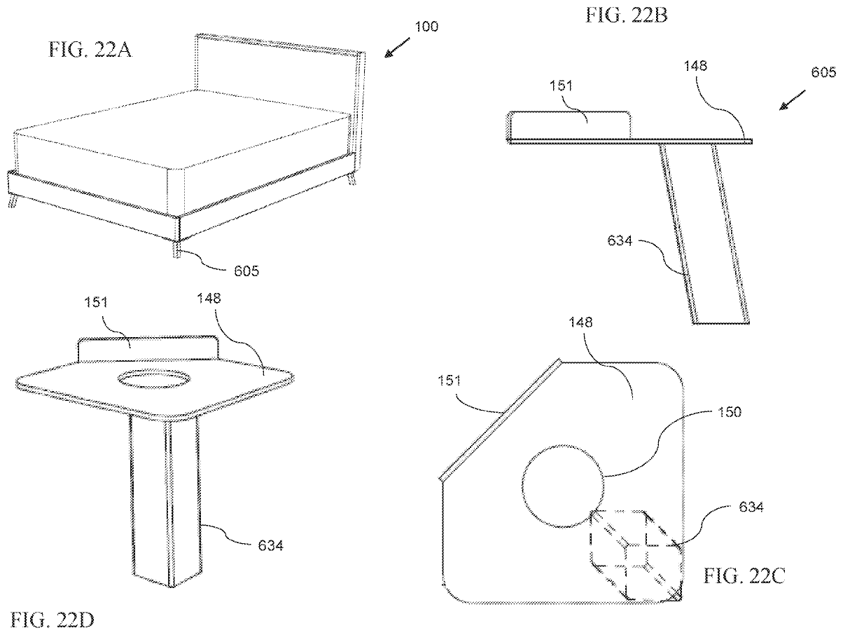

FIGS. 22A-22D illustrate the bed base (100) with an angled tubular leg assembly (605), where the angled tubular leg (605) comprises the large foot plate (148) with an angled tubular foot (634) welded thereto. This modular leg (605) can be selected to provide alternative aesthetics to the finished bed frame (100) and allow a user to customise the appearance of the frame (100). The leg assembly (605) can also be easily removed and replaced at any time where the user elects to change their decor and change the style of the frame (100). The leg assembly (605) provides the same foot plate (148) and locking flange (151) as described in relation to FIG. 17, while the foot (634) is tubular, providing an angular tubular profile on two exterior faces of the frame (109) once attached. The spacer (137) is internally positioned at the intersection of two rails, and each of the upper button (138) and the lower button (146) are screwed into the spacer (137) from opposing directions to located and tension the leg (305) to the frame (109). The foot (634) is angled at about 15 degrees to the vertical.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

Throughout the specification and claims, terms may have nuanced meanings suggested or implied in context beyond an explicitly stated meaning. Likewise, the phrase “in an embodiment” as used herein does not necessarily refer to the same embodiment or implementation and the phrase “in another embodiment” as used herein does not necessarily refer to a different embodiment or implementation. It is intended, for example, that claimed subject matter includes combinations of exemplary embodiments or implementations in whole or in part.

It is to be understood that, if any prior art publication is referred to herein, such reference does not constitute an admission that the publication forms a part of the common general knowledge in the art, in Australia or any other country.

As used herein and in the appended claims, the singular form of a word includes the plural, unless the context clearly dictates otherwise. Thus, the references “a,” “an” and “the” are generally inclusive of the plurals of the respective terms. For example, reference to “a feature” includes a plurality of such “features.”

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

The terminology used herein is for the purpose of describing particular example embodiments only and is not intended to be limiting. In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention

Legend

| Ref. | Description | Ref. | |
|---|---|---|---|
| 100 | Modular bed base | 126 | Head board support |
| 101 | Side rail | 127 | Threaded insert |
| 102 | Front rail | 528 | Interlocking profile |
| 103 | Back rail | 129 | Cutouts - aeration |
| 104 | Centre rails (support member) | 130 | Support platform |
| 105 | Legs | 131 | Storage space |
| 106 | Mounting feature | 132 | Platform modules |
| 107 | Slots | 133 | Bed head bracket sheath |
| 108 | Supplementary legs | 134 | Foot |
| 109 | Frame | 135 | Threaded sleeve |
| 110 | Cladding panels - planar | 136 | Collar |
| 210 | Profiled cladding panel | 137 | Spacer |
| 310 | Platform cladding panel | 138 | Button |
| 410 | Storage cladding panel | 139 | Lock screw |
| 510 | Overhang cladding panel | 140 | Dowel |
| 610 | Hook mounted cladding panel | 141 | External thread |
| 111 | Frame fasteners | 142 | Internal thread |
| 112a/b | Outer surface/Inner | 143 | Seat |
| 113 | 45 degree edge | 144 | Threaded stem |
| 114 | Cladding support | 145 | Knurled surface |
| 115 | Rounded edge | 146 | Secondary button |
| 116 | Scallops | 147 | Foot plate internal |
| 118 | Co-operating mounting | 148 | Foot plate external |
| | feature | | |
| 119 | Headboard | 150 | Foot plate aperture |
| 120 | Bed head | 151 | Locking flange |
| 121 | Curved bed head | 152 | Leg mounting aperture |
| 122 | Bed head brackets | 153 | Castor |
| 123 | Bed head bracket apertures | 154 | Mounting cup |
| 124 | Bolts | 155 | Rolling element |
| 125 | Support platform | | |

1-24. (canceled)

25. A modular bed base system, comprising:
a frame configured from a front rail, a back rail and a pair of side rails, the frame providing a plurality of mounting features;
a support member configured to engage with and span the frame, the support member extending parallel to the pair of side rails and disposed centrally of the front and back rails of the frame; and
a set of interchangeable cladding panels configured to form an ornamental perimeter about the frame, the set of interchangeable cladding panels selected from a plurality of sets of interchangeable cladding panels providing a selectable theme,
wherein each set of interchangeable cladding panels provides common co-operating mounting features adapted to releasably engage the mounting features of the frame to thereby vary at least one of shape, colour and texture of the ornamental perimeter in accordance with the selectable theme.

26. The modular bed base system of claim 25, wherein each set of interchangeable cladding panels comprises four panels to form a closed ornamental perimeter about the frame.

27. The modular bed base system of claim 25, wherein each set of interchangeable cladding panels comprises three panels and a bed head to form a closed ornamental perimeter about the frame.

28. The modular bed base system of claim 25, wherein the selectable themes comprise sets of interchangeable cladding panels varying at least one of: material; geometry; colour; padding; pattern; and texture.

29. The modular bed base system of claim 25, wherein the plurality of mounting features are selected from slots, keyholes, apertures, bosses, tabs, dimples, pegs, hooks, bolts, screws and dowels, and the plurality of cooperating mounting features are selected from slots, keyholes, apertures, bosses, tabs, dimples, pegs, hooks, bolts, screws and dowels.

30. The modular bed base system of claim 25, wherein the frame further comprises at least four legs, each leg mounted towards a periphery of the frame.

31. The modular bed base system of claim 30, wherein the support member comprises a pair of central rails.

32. The modular bed base system of claim 25, further comprising a supplementary leg mounted to the support member.

33. The modular bed base system of claim 25, wherein a first theme comprises a plurality of interchangeable cladding panels having a planar outer surface.

34. The modular bed base system of claim 25, wherein a second theme comprises a plurality of interchangeable cladding panels having a profiled or upholstered outer surface.

35. The modular bed base system of claim 25, wherein a third theme comprises a plurality of interchangeable cladding panels forming a ledge outwardly protruding from the bed base.

36. The modular bed base system of claim 25, wherein a fourth theme comprises a plurality of interchangeable cladding panels defining a storage zone within the frame.

37. The modular bed base system of claim 25, wherein a top of the frame is covered by a support panel.

38. The modular bed base system of claim 37, wherein the support panel is formed from a plurality of modular segments.

39. The modular bed base system of claim 25, wherein a fifth theme comprises a plurality of interchangeable cladding panels configured to hang from a periphery of the frame.

40. The modular bed base system of claim 39, wherein each interchangeable cladding panel has an “L-shaped” cross-section having a first portion that engages with a top of the frame and a second portion, connected with the first portion, that abuts the periphery of the frame so as to at least partially cover the frame.

41. The modular bed base system of claim 39, wherein a top of the frame is covered by a support panel formed from a plurality of interlocking segments.

42. The modular bed base system of claim 41, wherein edges of the support panel are configured to interlink with portions of the interchangeable cladding panels.

43. The modular bed base system of claim 39, wherein the plurality of mounting features protrude from outer facing surfaces of at least one of the front rail and the pair of side rails, to extend through corresponding apertures in the plurality of interchangeable cladding panels.

44. A bed, comprising:
a modular bed base system according to claim 25; and
a mattress supported thereon.
